(19) United States
(12) Patent Application Publication
(10) Pub. No.: US 2020/0165818 A1
(43) Pub. Date: May 28, 2020

(54) PANEL STAND ASSEMBLY

(71) Applicant: Mumble By Design Pty Ltd, Matraville, New South Wales (AU)

(72) Inventors: Nadine Fine, Matraville (AU); Jacqui Hawksworth, Matraville (AU)

(21) Appl. No.: 16/627,321

(22) PCT Filed: Jul. 10, 2018
(86) PCT No.: PCT/AU2018/050709

§ 371 Date: Dec. 29, 2019

(30) Foreign Application Priority Data
Jul. 10, 2017 (AU) 2017902698

(51) Int. Cl. E04B 2/74; F16M 11/42

(52) U.S. Cl. CPC E04B 2/7405; F16M 2200/08; F16M 11/42

(57) ABSTRACT

A panel support assembly is described. The panel support assembly includes a clamp, which includes at least one panel clamping jaw for clamping a portion of a panel; and a base operatively connected to the clamp at a joint. The joint is configured to rotate the base portion relative to the clamp portion. The base further includes a foot for engaging with a surface upon which the panel assembly rests.

### FIELD OF INVENTION

The present invention relates generally to panel stands. Embodiments of the invention relate to adjustable panel stands. In a particular, but not exclusive, embodiment, the invention relates to foldable panel stands for use on a desktop, table, or floor.

### BACKGROUND

Partitions are used in office space, schools, and shared spaces to separate one area from another. For example, some partitions may be used to separate spaces into cubicles, whereas other partitions may serve to separate smaller volumes such as a desktop or table workspace into portions. Partitions provide a level of visual privacy and noise reduction.

However, partitions can be heavy, clumsy and difficult to store and stack. It is with these limitations in mind that embodiments of the present invention were developed.

### SUMMARY OF THE INVENTION

In an aspect, the present invention provides a panel stand assembly comprising a clamp for clamping a portion of a panel, the clamp including at least one panel clamping jaw, and a base operatively connected to the clamp at a joint, the joint being configured to rotate the base portion relative to the clamp portion. The base further includes a foot for engaging with a ground surface or a flat surface such as a desk or floor.

In one embodiment, the base is configured to move relative to the clamp in a linear direction. In one embodiment, the clamp includes two panel-clamping jaws to clamp the panel portion therebetween. In one embodiment, the two clamping jaws are configured to cooperate, to removably fix to one another.

In one embodiment, the two clamping jaws are substantially identical to one another and may also include at least one connection element to connect the two clamping jaws together.

In one embodiment, the at least one connection element is configured to pass through an aperture in the panel. In one embodiment, at least one of the connection elements is disposed on or connected to the first panel clamping jaw to engage at least one connection element which is itself disposed on or associated with a second panel clamping jaw.

In one embodiment, the at least one connection element includes one of a tapered protrusion and a ribbed protrusion. In one embodiment, the at least one connection element includes a snap fit connector. In one embodiment, at least one panel clamping jaw includes a supporting flange to support the clamp on the base.

In one embodiment, one supporting flange on a first clamping jaw is disposed adjacent the supporting flange of a second panel clamping jaw. In one embodiment each supporting flange is configured to cooperate with an upper surface of the base portion so as to abut therewith and to slide or rotate thereon. In one embodiment the supporting flange is in an arch shape for increased strength.

In one embodiment the upper surface of the base portion is in an arch shape for additional strength. In one embodiment the arch shaped upper surface of the base portion includes a pair of outer arms depending downwardly from, and disposed on either side of, a central support table, the latter of which in operation provides a supporting bearing surface.

The foot may preferably include a gripping surface for engaging with the ground. The foot may include a ground-engaging surface treatment selected from the group consisting of scalloping, knurling, and tread. The joint may include an arm for engaging with one or other of the clamp or base. The base portion may include an aperture for receiving the arm. The arm may include a flanged end for keeping the arm within the aperture. The flanged end may include a snap-fit arrangement for connecting the clamp to the base. The joint may include a cam surface for guiding a cooperating follower on either the clamp or the base therealong. The cooperating follower may be disposed on the arm extending from the clamp.

The cam may be a helical ramp configured to guide the cooperating follower during relative rotation to linearly separate the base from the clamp.

In accordance with a further embodiment, the base of the panel stand assembly may include at least one wheel. Preferably, this at least one wheel may be retractable to within the base.

In accordance with another aspect the present technology may provide a panel stand assembly for supporting a panel having a peripheral boundary, the panel stand assembly comprising a clamp for clamping a portion of the panel, and a base operatively connected to the clamp portion by a joint, wherein the base is configured to move relative to the clamp between a stowed position in which the base is disposed within the peripheral boundary and a deployed position in which the base is disposed out of the peripheral boundary

In one embodiment, the arm includes a tapered end to be retained within the aperture. In an embodiment, the tapered end may include a snap-fit arrangement. In one embodiment, the aperture includes a cam surface for providing vertical movement dependent on rotation of the base relative to the clamp portion. In an embodiment, the tapered end may include a cooperating follower. The cam and follower arrangement provides such that the cooperating follower engages with the cam surface such that movement of the base portion relative to the clamp portion is a combined rotational movement and vertical movement. In another embodiment, the protrusion is formed to include a snap-fit arrangement to retain the protrusion in engagement with the base portion.

### BRIEF DESCRIPTION OF THE DRAWINGS

Further features of the present invention are more fully described in the following description of several non-limiting embodiments thereof. This description is included solely for the purposes of promoting an understanding of the present invention and not as an exhaustive list of essential features thereof. It should not be understood as a restriction on the broad summary, disclosure or description of the invention as set out above. The description will be made with reference to the accompanying drawings in which:

FIG. 1 illustrates an isometric view of a panel stand in accordance with an embodiment of the present invention;

FIG. 2 illustrates a side view of a panel stand in accordance with an embodiment of the present invention;

FIG. 3 illustrates an end view of a panel stand in accordance with an embodiment of the present invention;

FIG. 4 illustrates an isometric view of a panel stand in accordance with an embodiment of the present invention.

FIGS. 5a and 5b illustrate top and bottom view respectively of a panel stand in accordance with an embodiment of the present invention;

FIG. 6 illustrates an exploded view of a panel stand in accordance with an embodiment of the present invention;

FIG. 7 illustrates a section view of a panel stand in accordance with an embodiment of the present invention;

FIGS. 8a and 8b illustrate outside and inside views, respectively, of a panel arm in accordance with an embodiment of the present invention;

FIGS. 9a and 9b illustrate top and bottom views of a panel foot in accordance with an embodiment of the present invention;

FIG. 10 illustrates a side view of a panel in accordance with an embodiment of the present invention;

FIG. 11 illustrates a side view of a panel stand in accordance with an embodiment of the present invention; and

FIG. 12 illustrates an isometric view of a panel stand in accordance with an embodiment of the present invention.

FIG. 13 shows an isometric view of a panel stand in accordance with a further embodiment of the present invention including a wheel.

FIG. 14 shows an isometric view of the further embodiment of the panel stand as shown in FIG. 13 with the wheel in a retracted position within the base.

### DETAILED DESCRIPTION OF PREFERRED EMBODIMENTS

In the following detailed description, like numerals across different Figures refer to like features and/or integers.

Broadly, the present invention relates to a stand assembly suitable for supporting a panel. The assembly includes a clamp portion for engaging a portion of the panel and a base portion operatively connected to the clamp portion at a joint. The clamp includes at least one panel clamping jaw which is operatively connected to move relative to the base portion in both a rotational and linear direction.

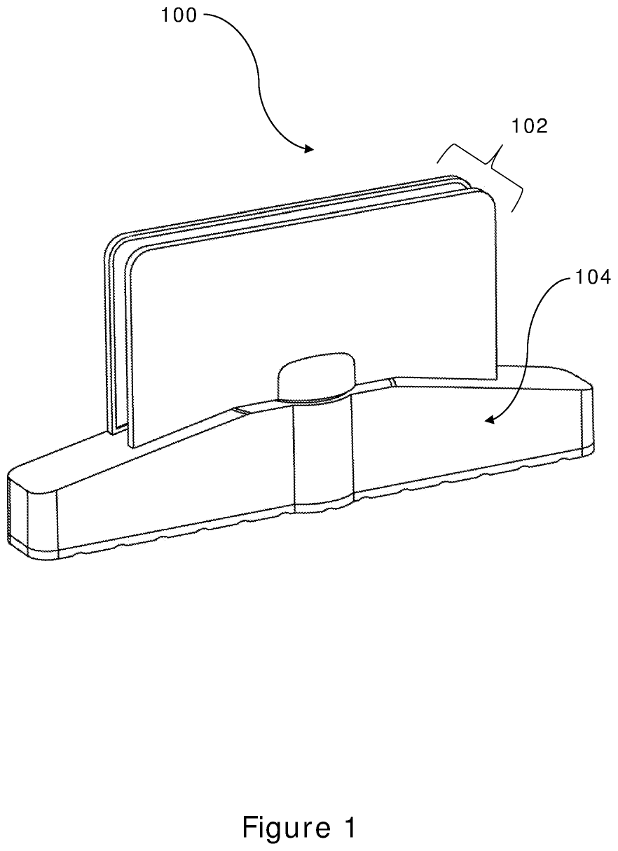

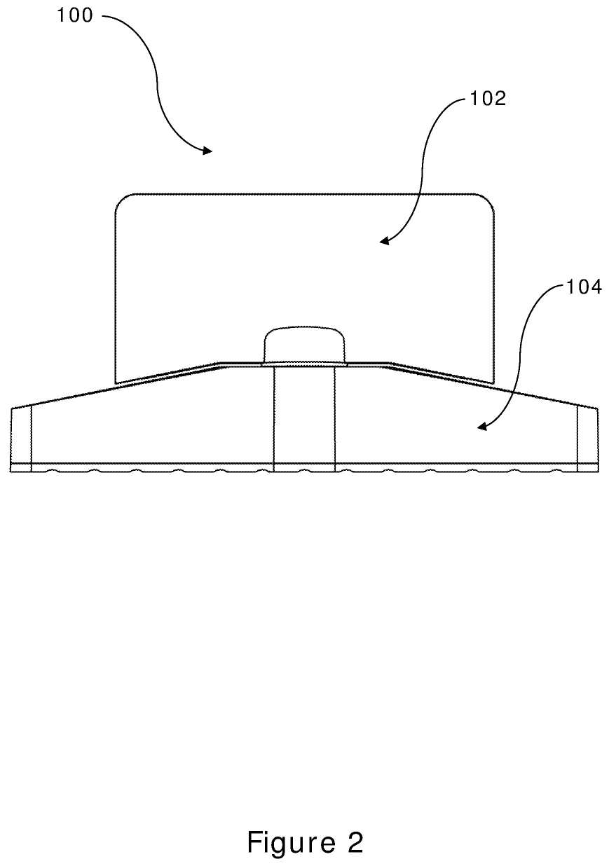

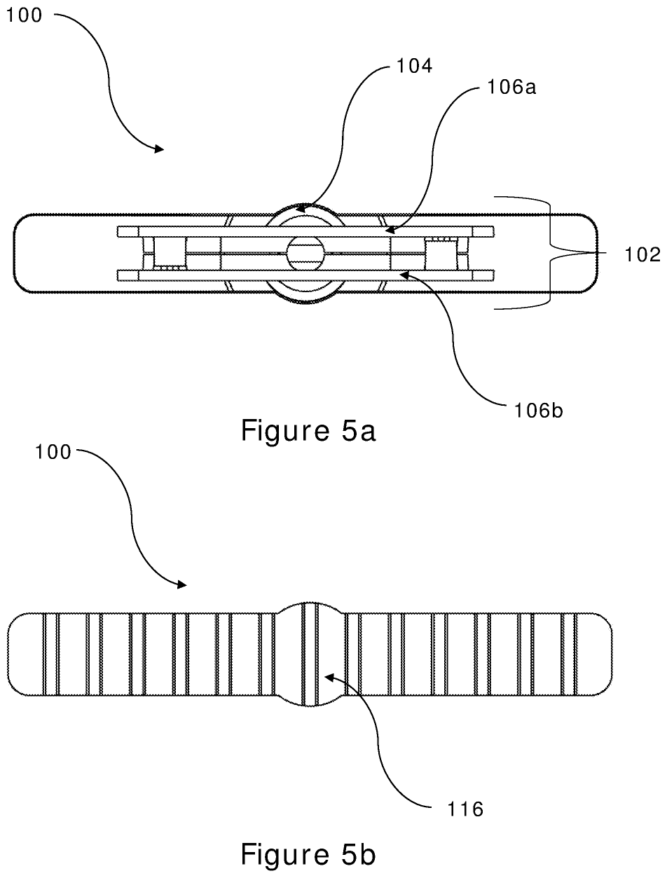

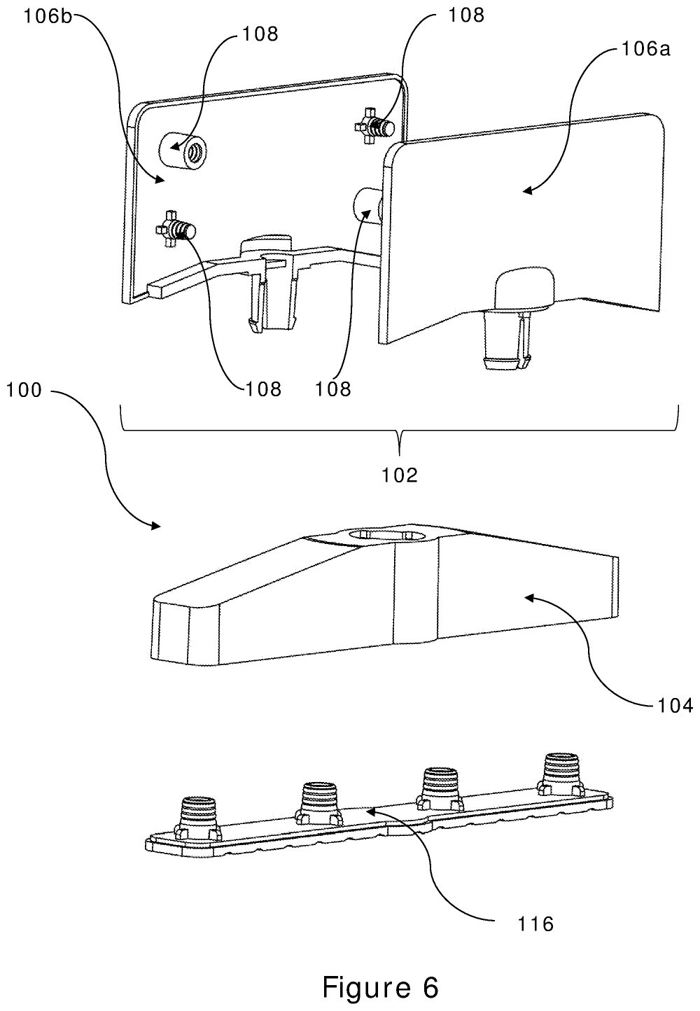

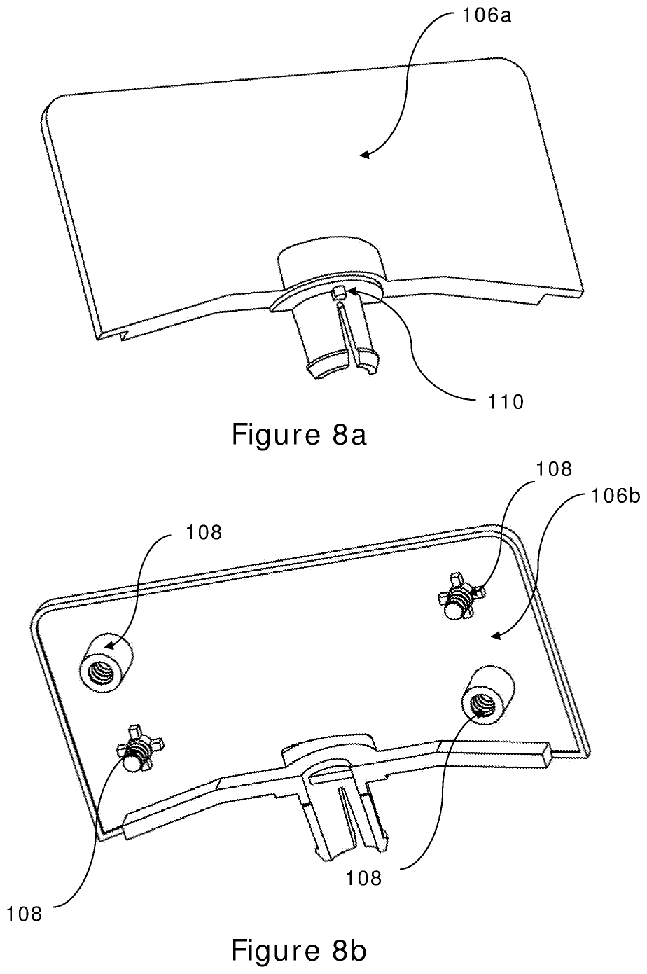

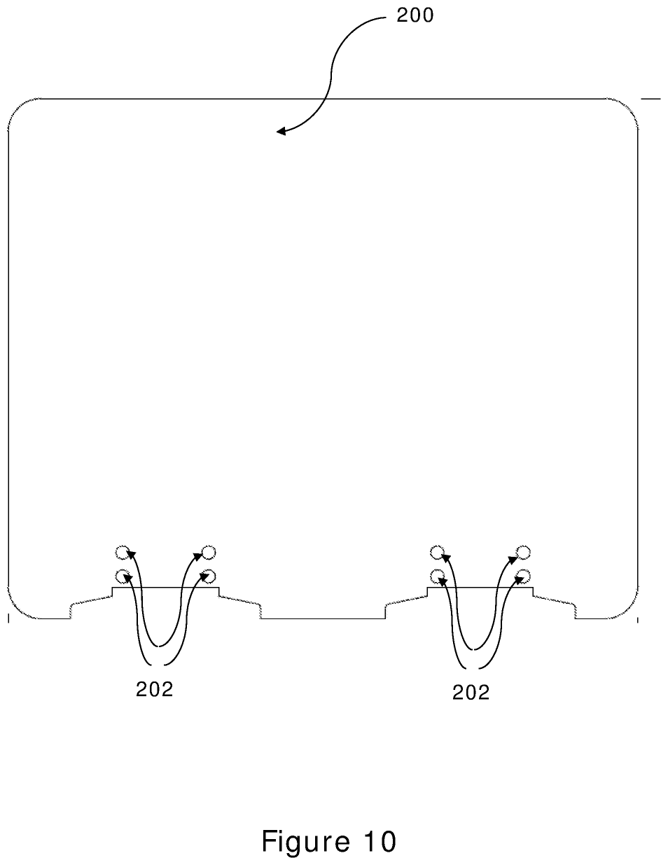

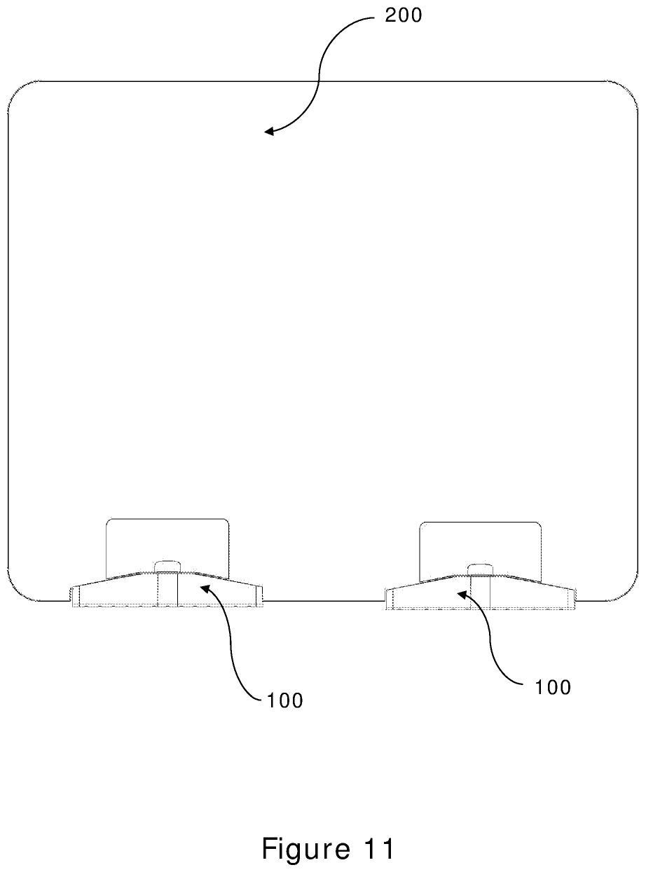

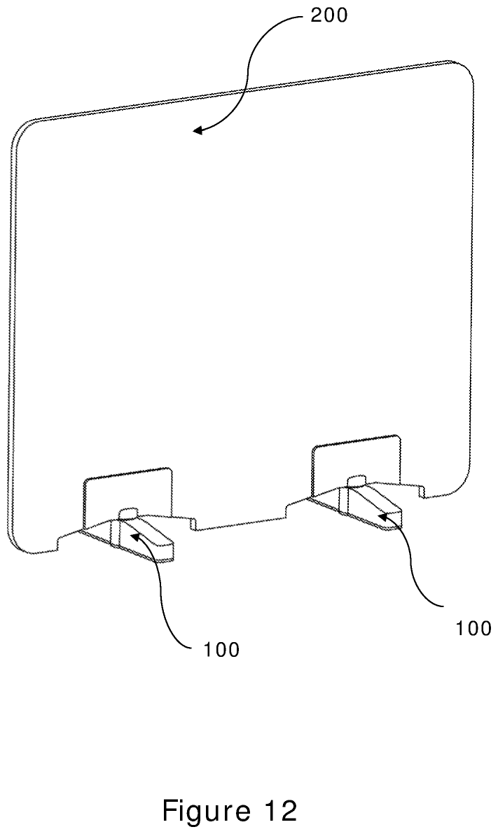

Referring now to the Figures, there is shown generally at FIGS. 1-9 and 11-12 a panel stand assembly 100 suitable for supporting a panel 200, with the corresponding panel 200 being shown at FIGS. 10, 11 and 12.

The panel stand assembly 100 includes a clamp 102 for engaging a portion of the panel 200 and a base 104 operatively connected to the clamp portion 102 at a joint. The base 104 also includes a foot 116 which may be removably attachable to the underside of the base 104.

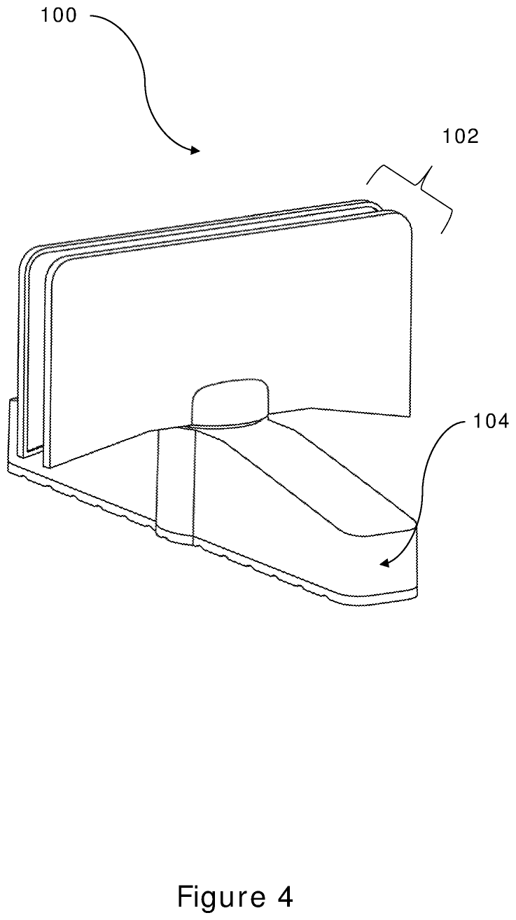

The clamp 102 includes at least one panel clamping jaw, which in this embodiment includes two panel clamping jaws 106a and 106b. As can be seen, in particular from FIG. 4, the base moves relative to the clamp portion, in one embodiment such that it moves in both a rotational and linear direction—rotating about a joint axis and extending by use of a helical ramp, or a cam surface, guiding a follower so as to separate the clamp from the base along the joint axis.

As can be seen from the Figures, the panel 200 is clamped, in the embodiment shown, between the two clamping jaws, 106a and 106b which are of a cooperating design, such that retaining portion 106a is arranged to fix to panel clamping jaw 106b to form the clamp 102. Put another way, the two panel clamping jaws are of an identical design, so that they may easily fit together and in the embodiment, interlock to hold the panel 200.

In more detail, the panel clamping jaws 106a and 106b each include two connection elements 108 (although one connection element or more than two connection elements are also contemplated, albeit not shown in the Figures). The two connection elements 108 are sized so that they can pass through preformed apertures 202 in the panel 200. However, it will be understood that in certain applications, the two connection elements 108 may include a sharpened tip or piercing element (not shown) arranged to pierce through the panel, such that the aperture is formed by the act of bringing the two retaining portions together around the panel 200. This feature would find use in situations where the panels are made from a relatively soft material, such as an expanded “foam”, such that a user may manually, through physical effort, cause the panel clamping jaws 106a and 106b to correspondingly pierce the panel 200 and also causing the two connection elements 108 of each respective retaining portion to come together and interlock, such that the panel 200 is securely held by the panel clamping jaws 106a and 106b.

As can be seen from the Figures, the connection element of a first panel clamping jaw engages with the connection element of a second panel clamping jaw by use of a tapered protrusion on one connection element and a ribbed protrusion on the other connection element. In the embodiment shown, the connection elements are locked into position by use of a snap fit connection, although other types of fit, such as a simple pressure fit, are also contemplated and are within the scope of a person skilled in the art.

Each panel clamping jaw also includes a supporting flange. In more detail, when the two panel clamping jaws are connected, each supporting flange is then disposed flush with the other to provide a wider supporting flange which supports the weight of the panel in use.

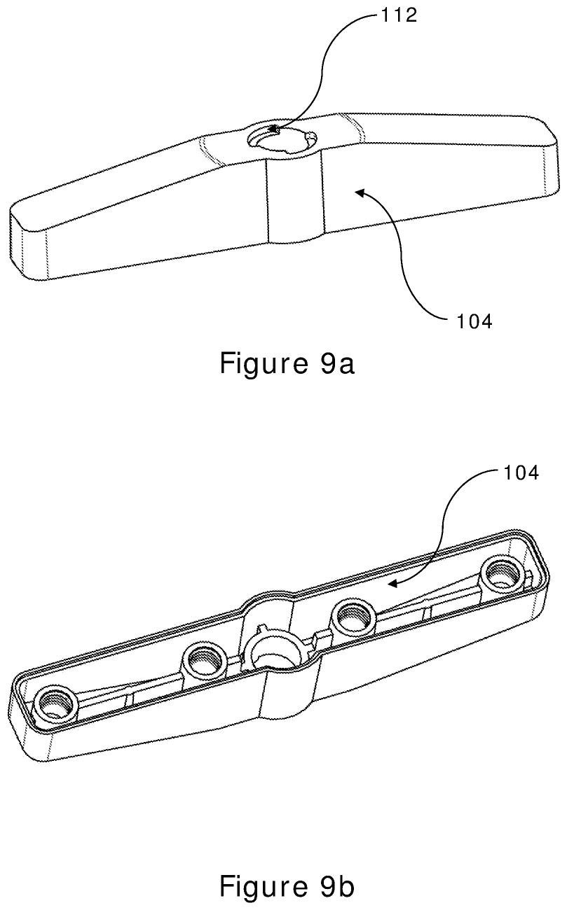

A joint is provided, which in the embodiment shown, includes an arm portion integral with and extending from a panel clamping jaw such that when brought in contact with another panel clamping jaw, forms a whole arm for engaging with the base portion. The base 104 includes an aperture for receiving the arm. In the embodiment shown, the aperture has a helical cam surface 112, which is best shown in FIG. 9a. The arm has a cooperating follower 110, so that the arm may in use ride along the cam surface 112 and during rotational movement of the base portion relative to the claim portion there is also vertical movement along the arm axis. In the embodiment shown, the cooperating follower 110 is a small protuberance that engages with the cam surface 112. However, it is be readily understood by a person skilled in the art that the follower 110 and cam surface 112 is not limited to any particular relative length of engagement or ramp inclination between the follower 110 and cam surface 112 within the workings of the present invention.

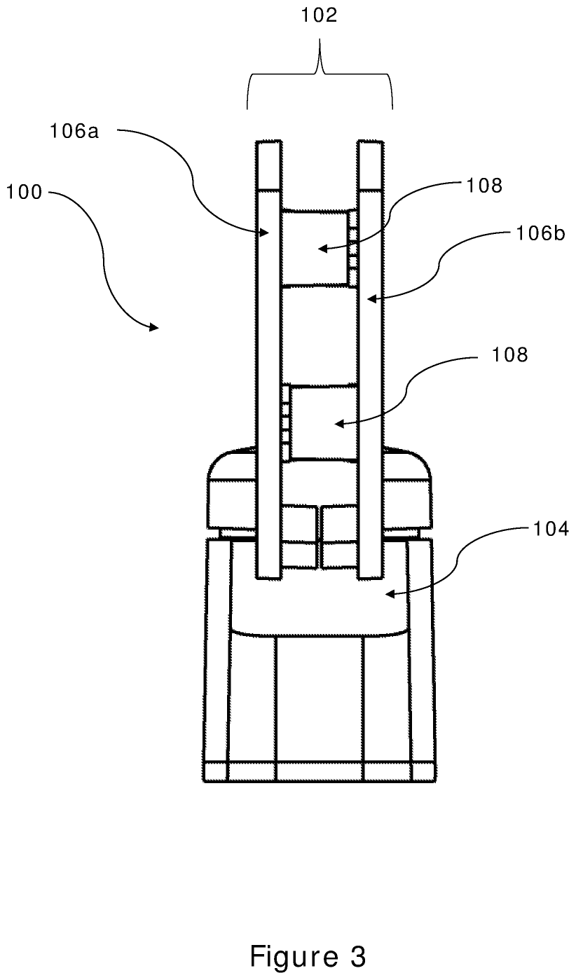

The joint may further include a stop that is configured to control the movement of the cooperating follower 110 relative to the cam surface 112. The stop may be provided to limit rotational movement of the clamp 102 relative to the base 104 to any point in a range of motion between 0 and 2π. An embodiment, best shown in FIG. 3, illustrates the panel stand assembly with a stop provided to limit the rotation of the clamp 102 relative to the base 104 to a rotation of π/2. Moreover, the joint may also include a number of notches (not shown) provided to the cam surface 112 to allow for discrete portions of rotational movement of the clamp 102 relative to the base 104.

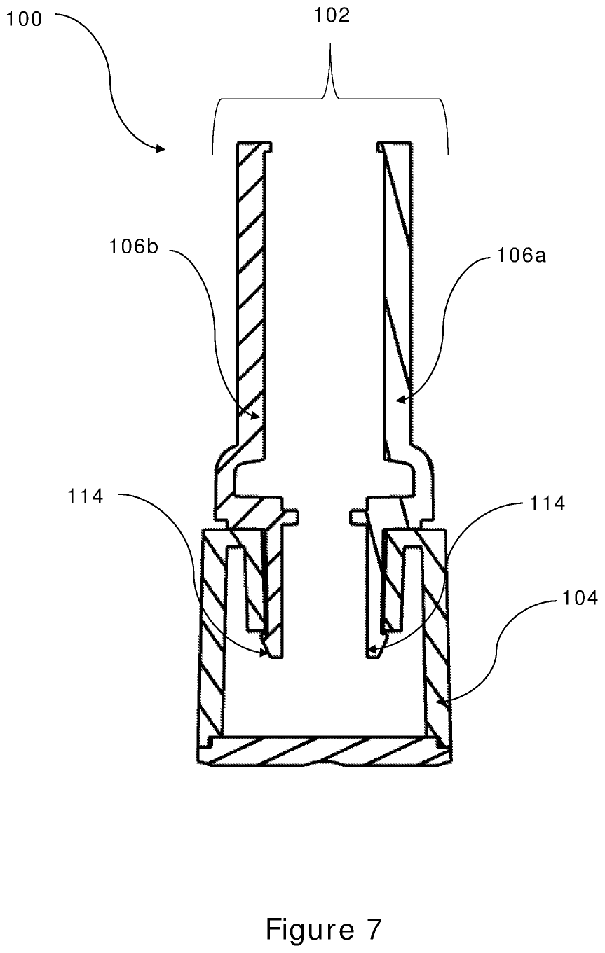

Each panel clamping jaw may also include an arm portion, which is formed to include a snap fit arrangement 114 to retain the arm in engagement with the base portion. As shown in FIG. 7, the lip formed on the arm of the retaining portions 106a and 106b engage with a corresponding recess formed within the aperture of the base 104. As would be readily understood by the skilled addressee, the snap fit arrangement 114 may be provided in combination or isolation from the engagement between the cam surface 112 and follower 110.

The foot portion may be comprised of a material with non-slip properties, such as rubber. The foot may also be comprised of a carpeted or plastic material that assists in preventing unwanted slippage of the panel stand in use. In the embodiment shown, the foot 116 may be removably attachable to the base 104 by means of tapered protrusions in the foot 116 and a ribbed protrusion on the underside of the base 104. The base and foot may also be removably attachable by means of a snap fit connection, although other types of fit, such as a simple pressure fit, are also contemplated and are within the purview of a person skilled in the art.

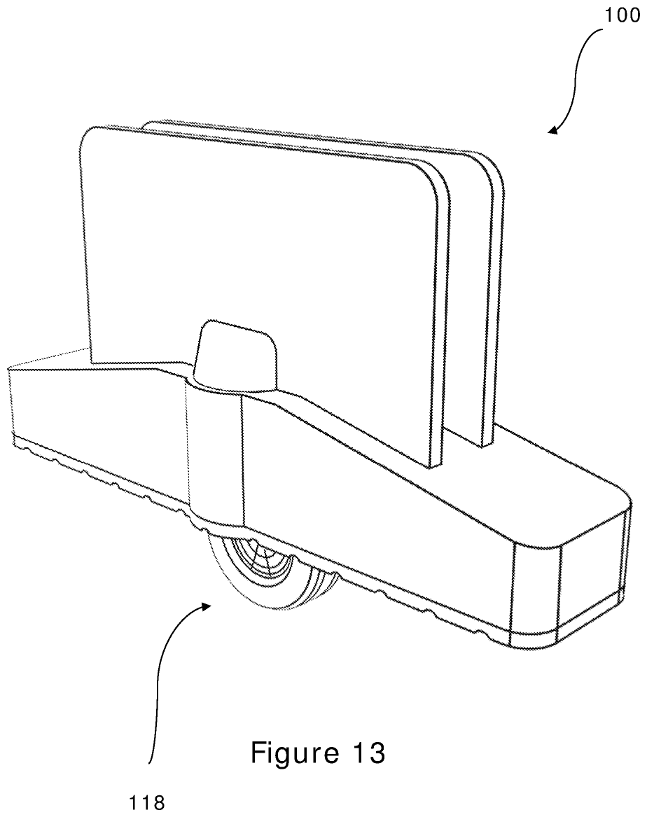

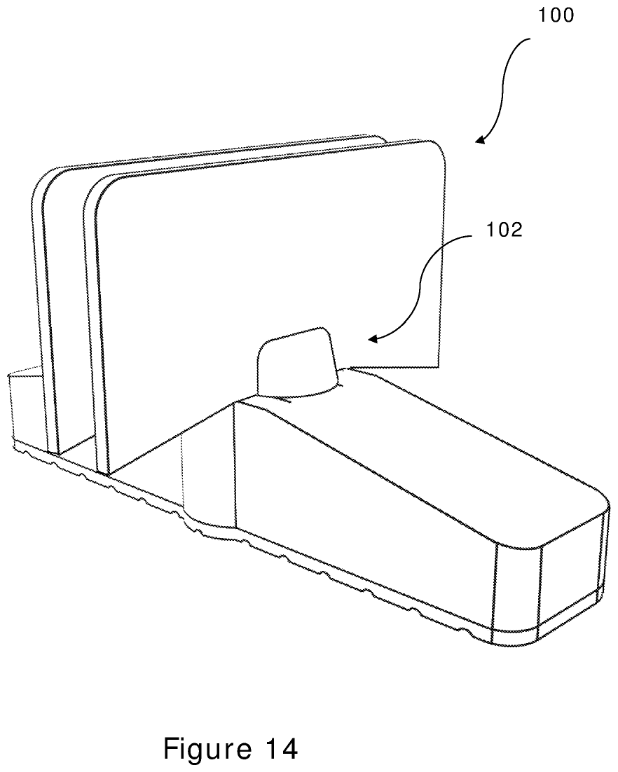

In an embodiment, the panel stand assembly 100 may include at least one wheel 118, as shown in FIG. 13. As in the embodiment shown, the wheel 118 may be mounted to an axle within the stand base 104. In a further embodiment, the wheel 118 may be retractable to within the base 104, as shown in FIG. 14 (wherein the clamp 102 has also been rotated).

The present invention is capable of being manufactured using a number of methods. By way of example, the adjustable panel stand as a whole or any portion of the adjustable panel stand may be manufactured by injection moulding. However, as is readily understood by a person skilled in the art, other methods of manufacture such as 3-D printing may also be used to manufacture the adjustable panel stand as a whole or any combinations of individual portions of the adjustable panel stand.

### Advantages

The embodiments and broader claimed invention herein provide a number of advantages, some of which arise from the features of a particular embodiment, others of which arise from the broader inventive concept.

Firstly, the symmetrical and reversible nature of the clamping portion provides manufacturing and assembly advantages. Such advantages may include, but are not limited to a cost advantage in that the manufacture of all clamping portions only requires a single design and manufacturing tool. It also provides further advantage in not requiring any wastage of mis-matched of clamp portions.

Secondly, the rotation of the base portion relative to the clamping portion allows the assembly to be “folded” into a substantially flat configuration, so that panels may be easily stacked.

Thirdly, the engagement of a portion of the panel by the clamp portion allows for the support of a panel without the requirement for any additional frame or structure to be provided the panel. This is especially advantageous for free standing panels, wherein the present inventions provides a means for supporting the panel in a streamlined and atheistically pleasing manner.

Throughout this specification, unless the context requires otherwise, the word “comprise” or variations such as “comprises” or “comprising”, will be understood to imply the inclusion of a stated integer or group of integers but not the exclusion of any other integer or group of integers.

Those skilled in the art will appreciate that the invention described herein is susceptible to obvious variations and workshop modifications other than those specifically described. Such variations are within the purview of a person skilled in the art.

Any reference to or discussion of known technologies in this specification or the claims is not to be taken as an admission that those technologies form part of the common general knowledge in Australia or in any other place.

Other definitions for selected terms used herein may be found within the detailed description of the invention and apply throughout. Unless otherwise defined, all technical terms used herein have the same meaning as commonly understood to one of ordinary skill in the art to which the invention belongs.

1. A panel stand assembly for supporting a panel having a peripheral boundary, the panel stand assembly comprising:
a clamp for clamping a portion of the panel, the clamp including; two panel-clamping jaws to clamp the panel portion therebetween, each clamping jaw including at least one connection element configured to pass through an aperture in the panel and having a snap fit connector to connect the two clamping jaws together, thereby securing the panel therebetween; and
a base, including a foot for engaging with a surface upon which the panel stand assembly rests, operatively connected to the clamp portion by a joint;
wherein the base is configured to move relative to the clamp between a stowed position in which the base is disposed within the peripheral boundary of the panel, and a deployed position, in which the base is disposed out of the peripheral boundary of the panel.

2-19. (canceled)

20. The stand assembly of claim 1, wherein at least one of the connection elements is disposed on or connected to the first panel clamping jaw to engage at least one connection element which is itself disposed on or associated with a second panel clamping jaw.

21. The stand assembly of claim 1, wherein the at least one connection element includes a tapered protrusion or a ribbed protrusion.

22. The stand assembly of claim 1, wherein at least one panel clamping jaw includes a supporting flange to support the panel clamping jaw on the base.

23. The stand assembly of claim 1, wherein one supporting flange on a first panel clamping jaw is disposed adjacent the supporting flange of a second panel clamping jaw.

24. The stand assembly of claim 22, wherein each supporting flange is configured to cooperate with an upper surface of the base portion to abut therewith, and slide or rotate thereon.

25. The stand assembly of claim 1, wherein the base is configured to move relative to the clamp in a linear direction.

26. The stand assembly of claim 1, wherein the joint includes an arm for engaging with one or other of the clamp or base.

27. The stand assembly of claim 26, wherein the base portion includes an aperture for receiving the arm.

28. The stand assembly of claim 26, wherein the arm includes a flanged end for keeping the arm within the aperture.

29. The stand assembly of claim 25, wherein the joint includes a cam surface for guiding a cooperating follower on either the clamp or the base therealong.

30. The stand assembly of claim 29, wherein the cooperating follower is disposed on the arm extending from the clamp.

31. The stand assembly of claim 29, wherein the cam provides a helical ramp configured to guide the cooperating follower during relative rotation to linearly separate the base from the clamp.

32. The panel stand assembly of claim 1 wherein the base portion further comprises a wheel, movable between a retracted and a deployed position;
wherein the wheel, when in the deployed position enables rolling movement of the panel stand assembly across the surface; and
when in the retracted position, the wheel is stowed within the base and does not engage with the surface.
